(19) United States
(12) Patent Application Publication
(10) Pub. No.: US 2017/0234284 A1
(43) Pub. Date: Aug. 17, 2017

(54) Woven Mesh Debris Shield for Fuel Injector

(71) Applicant: Stanadyne LLC, Windsor, CT (US)

(72) Inventor: Mark S. Cavanagh, West Granby, CT (US)

(21) Appl. No.: 15/497,478

(22) Filed: Apr. 26, 2017

Related U.S. Application Data
(63) Continuation-in-part of application No. 14/084,840, filed on Nov. 20, 2013, now Pat. No. 9,644,589.

(51) Int. Cl. F02M 61/16

(52) U.S. Cl. CPC F02M 61/165

(57) ABSTRACT

A debris shield in the high pressure fuel supply passage of a fuel injector, upstream of a bypass branch line leading to a control valve, comprising a rigid tube with a central passage aligned with the fuel supply passage and narrow flow paths through which high pressure fuel is filtered for removal of debris before delivery to the branch line, wherein the tube has opposed ends that are sealingly compressed between spaced apart stop surfaces along the fuel supply passage. The flow paths can be can be bores, slots, or circuitous transverse flow paths formed by woven or ribbon wrapped mesh.

### RELATED APPLICATION

This application is a continuation-in-part of U.S. application Ser. No. 14/084,840, filed Nov. 20, 2013, for “Debris Diverter Shield For Fuel Injector”.

### BACKGROUND

The present invention relates to fuel injectors, particularly for vehicle internal combustion engines.

In a well-known type of fuel injector, an injection valve is hydraulically opened and closed by the opening and closing of a solenoid actuated control valve. Both valves are subject to highly pressurized fuel from a supply pump or common rail. To reduce engine emissions, fuel systems are being designed for injection at higher and higher pressure. To seal high pressure fuel during closure of the control valve, it is necessary to increase the hold-down force and thereby avoid seat leakage at these higher pressures.

The higher control valve seating force increases the potential for seat damage when debris gets trapped or crushed in the opening and closing control valve. To meet more stringent emissions regulations it has been found that injecting fuel multiple times during one combustion event is required. To achieve fast opening and closing of the fuel injectors, faster opening and closing control valves with less valve lift are being adopted. Control valve lifts under 50 microns are common. Ideally, debris should to be small enough to pass through the valve seat area.

Debris that gets trapped in the seat area will continue to damage that seat as it opens and closes. This significantly reduces the life of the injectors. When damaged, control valve seats no longer seal properly. Fuel delivered by the fuel injector tends to increase when control valve seats leak. This performance change results in unintended fuel delivery increases which can cause engine damage due to over fueling and also rough engine operation due to uneven fuel delivery into the various engine cylinders. As a consequence, the most common reason for replacing fuel injectors is performance problems caused by control valve seat damage.

Techniques are known for addressing this problem to some extent. The fuel from the fuel tank is filtered through multiple filters prior to reaching the fuel injector but some debris gets through these filters. Primary and secondary filters are located between the fuel tank and the entrance to the high pressure fuel pump. At the entrance to the fuel injector a third, small filter functions at the high pressures produced by the high pressure pump. The primary and secondary filters trap about 99% of the debris in the fuel prior to entering the high pressure fuel pump. The remaining debris in the fuel and additional debris from components such as the high pressure pump become trapped in the small filter (typically an edge filter or laser drilled filter).

Filters used to capture debris at the entrance of the injector are challenging to design at a reasonable cost. These filters typically are not serviced over the life of the injector and to avoid plugging, are theoretically designed to allow debris particles smaller than 30 microns to 60 microns in diameter to pass. In general, however, the filter at the entrance to the injector typically will permit particles smaller than about 50 microns to pass. This does not present a plugging problem with respect to the discharge holes for fuel injection, which are typically larger than 100 microns, but does present a problem for the durability of the control valve. Rod-shaped particles that have a diameter under 60 microns but a length of up to 150 to 200 microns can still pass through the entrance filters. These particles cause damage if they pass into the control valve.

Even if the edge region of an entrance edge filter is designed with a 50 micron passage, larger particles are not permanently trapped but, rather, extrude through the passage as rods or flakes with an effective diameter of about 50 microns. Thus, the overall volume of debris reaching the control valve is reduced somewhat by the typical entrance filter but sufficiently large size particles can still reach the control vale and cause damage. The control valve must hammer the extruded debris down to a size that will pass through the control valve.

### SUMMARY

The object of the present invention is to significantly decrease debris damage to a hydraulic component within a fuel injector, particularly a control valve for a needle injection valve, by limiting the debris that reaches the component to a size that can readily pass through the component.

In the case of such control valve, the debris is preferably limited to an effective diameter of less than 50 microns, especially less than 25 microns.

This object is achieved by providing a simple, tubular bypass filter device in a small space inside the injector, which remains in place during the life of the injector without plugging. The tube has a central passage aligned with the main, high pressure fuel supply passage and a multiplicity of perforations defining very narrow direct or indirect paths through which high pressure fuel is filtered for removal of debris before delivery through a branch line bypass to the control valve. The tube is mounted by axial compression at the opposite ends, thereby preventing debris having an effective size greater than a threshold, such as 30 microns, from passing between the ends of the tube and the compression actuation surfaces.

The tube has a neutral length between opposed ends that is greater than the space between stop surfaces in the high pressure fuel supply passage, whereby in the assembled injector the tube length is shortened by compression between the stop surfaces.

In one aspect, the disclosure is directed to a debris shield in the high pressure fuel supply passage upstream of a branch line leading to the control valve, comprising a tube fixed to the injector body, with a central passage aligned with the main fuel supply passage and a multiplicity of transverse holes through which high pressure fuel is delivered to the branch line. In this way, high pressure fuel for injection passes axially through the tube and high pressure fuel to the upstream side of the control valve passes radially through the holes in the tube.

Damaging debris has higher density than fuel, so the debris is more likely to travel past the small holes, which are preferably 90 degrees to the main flow. The small holes (approximately 20-25 microns) are less likely to plug due to the 90 degree change in particle direction required for the particles to enter the small holes.

The debris at the entrance to the holes is not subject to a significant pressure drop across the holes so, unlike in edge filters, no extrusion forces arise that would otherwise force larger particles through the holes. The transverse entrance to the holes acts like a shield to minimize the penetration of debris into the holes. Furthermore, larger particles at the entrance to the holes are flushed away (i.e., diverted) from the holes in the main axial flow through the tube. Thus, large particles are neither accumulated nor extruded, and particles that do pass through the diverter shield have an effective size that enables them to pass readily through the control valve without being hammered to a smaller size.

In one mounting embodiment, the injector body comprises an upper portion containing the control valve and an upper portion of the fuel supply passage, a lower portion containing the injector valve and a lower portion of the fuel supply passage, and a distinct central plate portion having upper and lower surfaces rigidly trapped between the upper and lower portions of the body and a debris shield chamber fluidly connecting the upper and lower portions of the fuel supply passage. The debris shield is situated in the shield chamber, with opposed ends extending from the upper to the lower surface of the central portion of the body. The tube is fixed to the body in longitudinal compression between the upper and lower portions of the body.

The placement of the debris shield in a central plate with slight protrusions of the tube above the plate, allows the tube to be crushed a controlled amount. The plate thickness is easy to control to close dimensions. The unique configuration of the tube into the plate is very beneficial as a low cost modification and for ease of manufacturing. Because the tube is made of material that can yield without cracking, the dimensional control of the tube length is relaxed, which helps reduce cost. The tube is crushed and slightly yielded to assure that it seals against the upper and lower portions of the body. It is important to seal the tube on both ends to assure that no leakage occurs that would allow large particles to enter the control valve fluid passages.

The main characteristics of the tube are rigidity and narrow transverse flow paths that permit a filtered transverse flow of fuel through the tube wall, while diverting and/or capturing debris having an effective length greater than of a threshold maximum, such as 30 micron. The main characteristic of the mounting is that the axial ends of the tube are compressed between actuation surfaces such that any tendency of radially outward flow of fuel at the ends is either blocked or filtered within the same criteria as the main body of the tube. The compression at the ends of the tube can be effected perpendicularly on the end faces of the tube, or obliquely adjacent the end faces. Thus, many kinds of tubular filters are potentially usable for implementing the present invention. In particular, two types of mesh filters are suitable.

In one mesh embodiment, the tube wall comprises a plurality of layers of metal ribbon filaments, each layer wrapped obliquely to the axis at an intersecting angle relative to an adjacent layer, thereby forming a multiplicity of circuitous flow paths passing entirely through the tube wall. Each pair of overlapping wraps with intersecting filaments can be considered a layer of mesh; in this case, a tube of three wraps would have two layers of mesh.

In another mesh embodiment, the tube wall comprises at least two distinct layers of mesh, each layer defining openings between filaments, with an inner layer forming the inner surface of the tube and defining relatively larger openings and an outer layer forming the outer surface of the tube and defining relatively larger openings. These openings form the inlets and outlets of a multiplicity of circuitous flow paths passing entirely through the tube wall, whether or not an intermediate reinforcement or mesh layer is present.

Satisfactory results can be obtained when about 40% surface porosity is used to estimate open flow area.

The mesh tubes are rigid, preferably due to sintering of the layers together, and thus can withstand axial compression forces at the ends, without collapsing the openings between the end faces. The compression level or crush interface for sealing the ends, is preferably in the range of about 0.175-0.025 mm.

In this variation, a debris shield comprises a tube fixed to the body, with a central passage aligned with the fuel supply passage and a tube wall consisting of a plurality of layers of metal mesh that together define a multiplicity of circuitous flow paths passing entirely through the tube wall. At least one layer of the metal mesh consists of intersecting filaments that define distinct openings; and each layer is rigidly attached to an adjacent layer, as by sintering.

### BRIEF DESCRIPTION OF THE DRAWING

Embodiments of the invention will be described below with reference to the accompanying drawing, in which:

FIG. 1 is a longitudinal section view of a fuel injector that incorporates a first mounting embodiment of a tubular filter shield;

FIG. 2 is a detailed section view of the first embodiment;

FIG. 3 is a detailed view of a second mounting embodiment;

FIG. 4 is a photomicrograph of the surface of a woven mesh for the tubular debris shield, which surface would at the interior wall of the tube;

FIG. 5 is a photomicrograph of a section through the mesh of FIG. 4;

FIG. 6 is a schematic of the material used to make another, wound ribbon mesh type of tubular debris shield; and

FIG. 7 is a detailed section view of a mesh tube in a third mounting embodiment, whereby the bottom end of the tube is compressed at the end face whereas the top end of the shield is compressed buy a conical stop surface acting obliquely adjacent the face.

### DETAILED DESCRIPTION

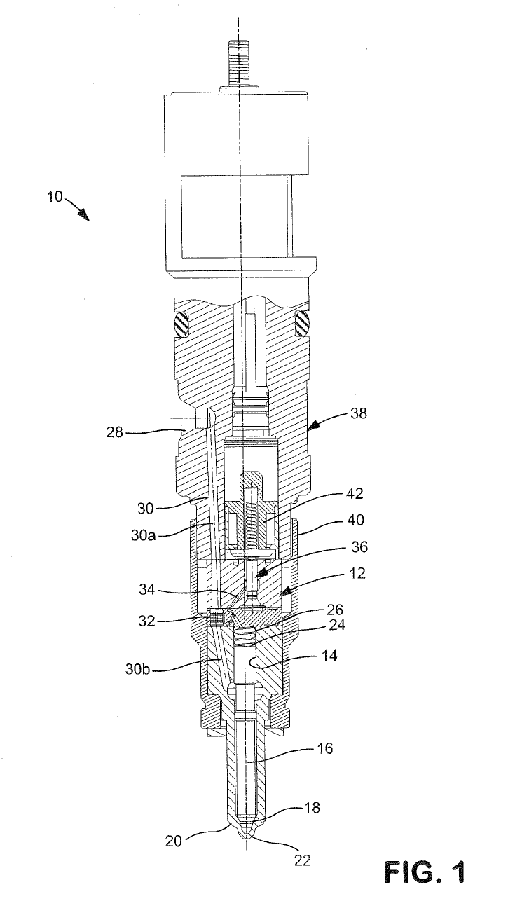

FIG. 1 shows an injector 10 that embodies one aspect of the present invention. The injector has a body 12 including a central bore 14 in which a needle valve 16 reciprocates axially to selectively seal against and lift off seat 18 in the lower portion near tip 20 of the body. A plurality of injection holes or orifices 22 are formed in the tip below the valve seat 18. The needle valve 16 has an upper end 24 situated in a needle control chamber 26 whereby a combination of hydraulic and spring forces selectively close the nose of valve 16 against seat 18 or lift the valve 16 from the seat 18, depending on the pressure in chamber 26.

After passing through a high pressure filter (not shown), high pressure fuel is supplied to the injector through port 28 into main passage 30, having upper portion 30a, which leads to the valve body 12, and lower portion 30b, which is in fluid communication with the bore 14. In a well-known manner, differential area profiles and fluid volumes on and around needle 16 achieve the desired hydraulic balances such that high pressure fuel is selectively discharged through orifices 22. When the needle valve 16 is to be closed, high pressure fuel in the needle control chamber 26 urges the injector valve 16 against the injector valve seat 18 to prevent flow of high pressure fuel from the bore 14 to the orifices 22 and when the needle valve is to be opened the needle control chamber 26 is fluidly connected to low a pressure sump, thereby reducing the fluid pressure in the control chamber 26 and on the upper end 24 of the needle valve 16, lifting the needle valve off the injector seat 18 and discharging fuel through the orifices 22.

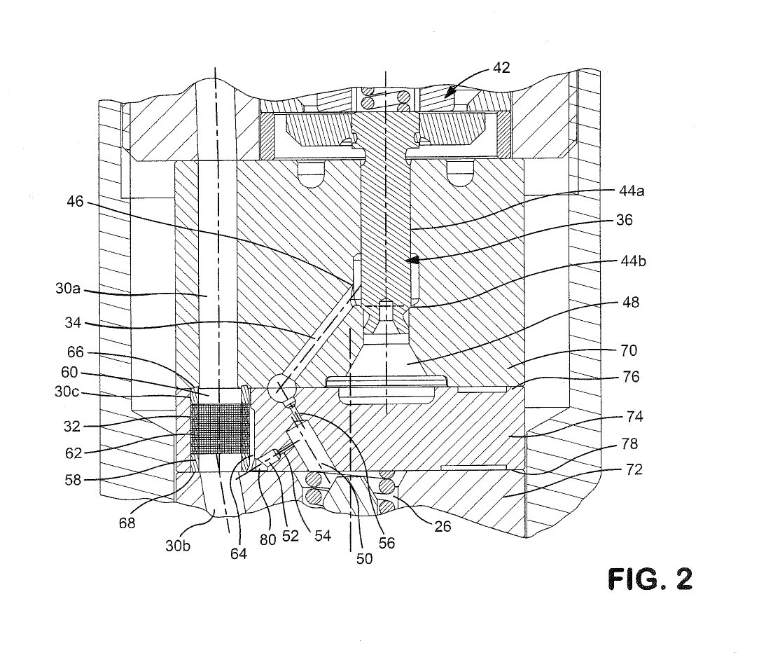

With reference to FIGS. 1 and 2, the invention provides a debris shield 32 within the injector, where some of the high pressure fuel is delivered from the high pressure supply passage (e.g., 30a) via auxiliary passage or branch 34 to control valve 36. Control valve 36 is in fluid communication with and controls the pressure in the needle control chamber 26, thereby closing and opening the needle valve 16. An actuator body 38 is connected to the valve body 12 by threading to a substantially tubular body connector 40, and contains a solenoid actuator 42 for a pintle 44a or the like that seals against and lifts from seat 44b. Seat 44b is located such that an upstream region 46 of the control valve chamber is in fluid communication with high pressure passage 34 and a downstream region 48 is in fluid communication with a low pressure sump, such as the fuel tank or low pressure fuel delivery line to the high pressure supply pump.

In the illustrated embodiment, the auxiliary flow from high pressure supply passage 30a enters passage 50 via passage 52, the former being in direct fluid communication with the needle control chamber 26 and with passage 34. Preferably, the auxiliary passage 52 includes an orifice 54 leading to passage 50, and another orifice 56 is situated between passage 50 and passage 34.

The debris shield 32 is in the intermediate portion 30c of the high pressure fuel supply passage 30, between portions 30a and 30b. The debris shield comprises a rigid tube 58 with a central axial passage 60 and a multiplicity of radial openings 62 in the tube wall. High pressure fuel for injection passes axially into and out of the tube 58 and high pressure fuel to the upstream side 46 of the control valve 36 passes radially through the holes 62 in the tube. In the illustrated embodiment, the debris shield is in the high pressure fuel supply passage 30c upstream of branch passage 52, whereby radial flow through the debris shield enters the passage 50 and passage 34. However, inasmuch as the main purpose of the debris shield is to prevent debris from entering the control valve 36, the upstream flow path 34 can be directly fluidly connected to the fluid volume where the radial flow exits the debris shield.

It should thus be appreciated that the debris shield 32 is in the main high pressure fuel supply passage 30, upstream of the branch line 34 leading to the control valve 36, and comprises a tube 58 fixed to the body 12, with a central passage 60 aligned with the fuel supply passage and a multiplicity of transverse openings 62 and associated circuitous flow paths through which high pressure fuel is delivered to the branch line 34.

The debris shield 32 is preferably situated in a shield chamber 64 in the body, defined by a shield chamber wall spaced radially from the tube. The tube has opposed ends 66, 68 and the tube is fixed to the body at the ends. Preferably the valve body 12 comprises an upper portion 70 containing a vertical portion of high pressure supply passage 30a, control valve seat 44b, and upstream entry point 46 of passage 34 to the seat 44b. The valve body 12 also includes a lower portion 72 containing the injector valve 16, needle control chamber 26, and the lower portion 30b of the fuel supply passage 30. A distinct central portion 74 of the valve body 12 in the form of a plate having upper and lower surfaces 76, 78 is rigidly trapped between the upper and lower portions 70, 72 of the body. The shield chamber 64 fluidly connects the upper and lower portions 30a, 30b of the fuel supply passage. Auxiliary passage 52, passage 50 to the needle control chamber 26, and orifices 54 and 56 are also preferably located in the central plate 74.

The nominal distance between opposed ends 66, 68 of the tube 58 is preferably greater than the distance between the upper surface 76 and the lower surface 78 of the central portion 74 of the body, However, in the assembled condition of the injector, the body portions 70, 72, and 74 are pulled tightly together by the body connector 40 (See FIG. 1) so that tube 58 is fixed to the body in longitudinal compression between the upper and lower portions 70, 72 of the body.

The shield chamber 64 preferably includes a collection gallery 80 at the intersection with the auxiliary passage 52. All the fuel supplied to the passage 34 must pass through the holes 62 and gallery 80. Preferably, the gallery extends to the lower surface 78 of the central portion 74 of the body, and auxiliary passage 52 extends from the lower surface of the central portion of the body from the gallery at an oblique upward angle toward the axis of the bore 14. Passage 50 terminates within the central portion 74 of the body between the first and second orifices 54, 56 and is oriented along an axis from the injector control chamber obliquely upward toward the first portion 30a of the fuel supply passage.

It should be further appreciated that a debris diverter shield can be located anywhere within the injector whereby a main high pressure fuel flow passes axially through the tube and a secondary or auxiliary flow passes transversely through the perforations to a component within the injector that is vulnerable to the presence of small particles of debris. Particularly in the illustrated and analogous embodiments, the pressure drop across the tube is relatively small. For example, while the control valve 36 is closed, there is substantially no pressure drop because the passages to the control valve are at the pressure of the fuel in supply line 30. When the control valve 36 opens, the orifices such as at 54 and 56 maintain a relatively high pressure in the gallery 64. Even with pressure in the main passage 30 above 20,000 psi, the pressure drop across the tube can be as low as about 30 psi.

The combination of robust main flow axially through the tube, transverse orientation of the openings 62, and small pressure drop across the tube, avoids substantial transverse forces on the particles so they are not prone to extruding through the holes. Due to the low transverse forces on the particles they tend to remain near the entrances to the perforations and are immediately flushed by the main flow to the region of the injector where they can easily pass through the injection orifices.

It should be understood that in a typical implementation for a passenger vehicle, the debris diverter shield 32 would have a length in the range of about 3-4 mm, an OD of about 2.5 mm, and an ID of about 1.5 mm (e.g., with a wall thickness in the range of about 0.1 to 0.5 mm). However, the dimensions of the diverter shield would be correspondingly larger for heavier end uses.

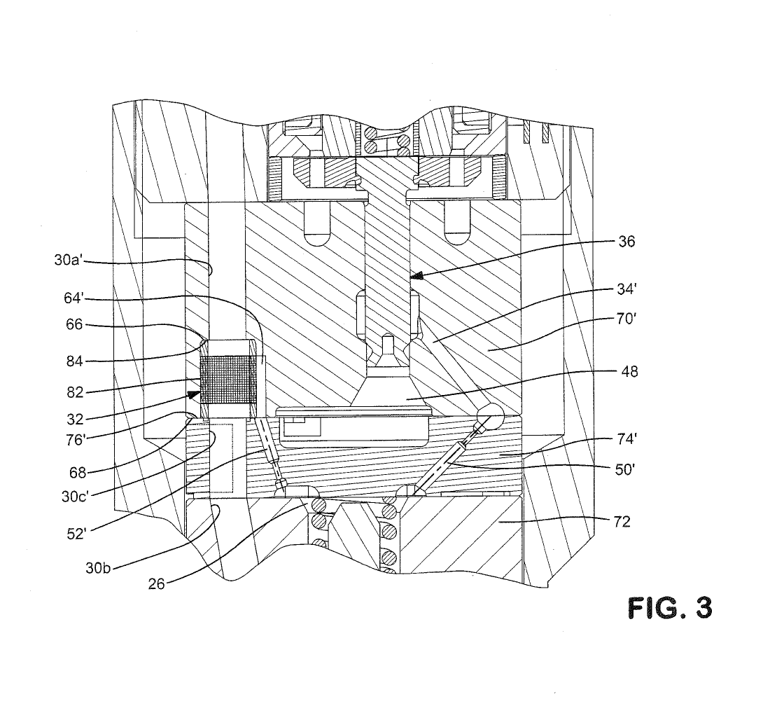

FIG. 3 shows a second embodiment in which the debris diverter shield 32 is in a different location within the injector, and the associated passages for achieving control of the injector differ from those shown in FIG. 2. In FIG. 3, components that are identical to those shown in FIG. 2 carry the same numeric identifier, whereas components that are not identical but provide the same or similar functionality are indicated with a prime (I In this embodiment, the debris shield 32 is located in the upper portion 30a′ of the high pressure passage within the upper block 70′, and the lower portion 30b in block 72 and intermediate portion 30c′ in block 74′ are straight bores.

The lower portion of passage 30a′ has a counter bore 82 defining an internal shoulder 84. The upper end 66 of the diverter shield 32 bears against the shoulder 84 and the lower end 68 of the diverter shield 32 bears against the upper surface 76′ of the intermediate block 74′. As with the embodiment of FIGS. 1 and 2, the diverter shield 32 is thereby compressed and rigidly held in position.

High pressure fuel in passage 30a′ enters the debris diverter 32, with some flow passing through the transverse holes into gallery 64′, branch line 52′ and into the needle control chamber 26. While the control valve 36 is closed, high pressure is maintained in the needle control chamber 26, passage 50′ and passage 34′. Upon lifting of the control valve 36, this pressurized fuel is exposed to the low pressure at 48, thereby inducing the lifting of the needle valve within chamber 2.

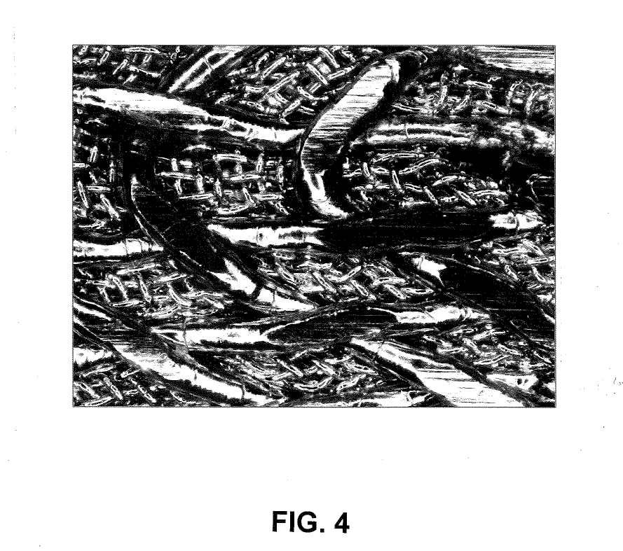

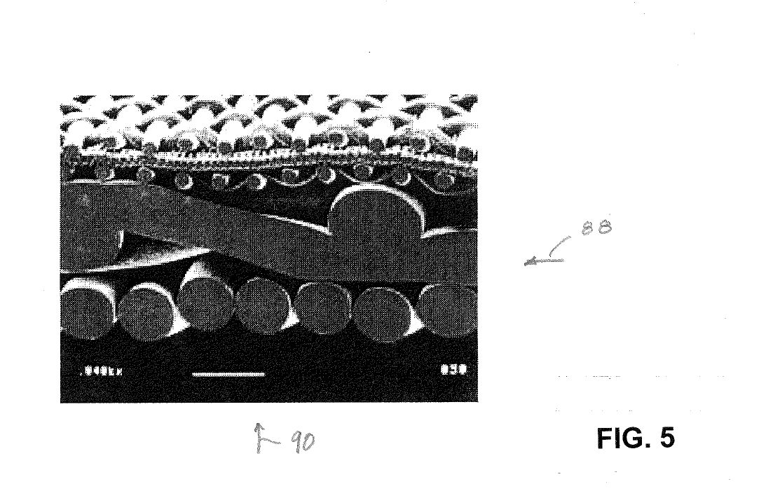

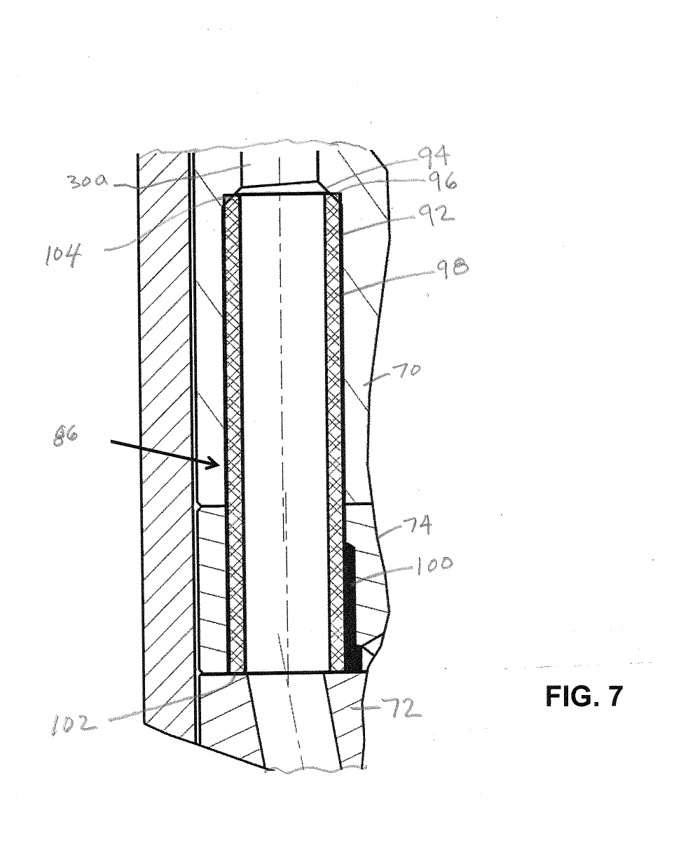

Similar or even better performance can be obtained by using a tubular mesh debris diverter instead of a drilled cylinder. FIG. 7 depicts such a tubular mesh shield 86 installed in an injector. FIG. 4 is a photomicrograph of the inside surface of a woven mesh tube wall and FIG. 5 is a photomicrograph of a section through a mesh of the type shown in FIG. 4. Arrow 88 indicates the direction of the main flow and arrow 90 indicates the direction of the filtered flow that is diverted radially outward from the main axial flow through the tube. Whereas a woven mesh filter was known for use in a fuel injector, the flow was either radially inward or radially outward, but not a combined axial and radial flow. The filter was more cup-shaped, not tubular, because one end was crimped. In the present invention, both ends are open for the main, axial flow.

Given the objective of preventing debris larger than 30 micron, preferably 20 micron, from passing anywhere through the tube to the control valve, both end faces of the tube must be functionally sealed in a manner analogous to that described with respect to FIGS. 1-3. This is accomplished by compressing the faces against respective upper and lower plates. The mesh crushes locally and any open area at the peripheral interface with the plates of the injector body is small enough to block debris. The crushing of the mesh at the end faces reduces the transverse flow paths, for either full blockage or else the density of the mesh is so high that it is even more effective than the main shield area of the tube.

Whether considered through the main mesh body or at the sealing of the end faces, the overall pressure drop across the woven mesh type filter should be lower than across a functionally similar tube filter with drilled radial holes. This reduces the sealing demands at the end faces. Whereas in the drilled tube the main barrier to debris is the combination of small holes and the difficulty of debris in the axial flow stream from making a 90 degree turn into a hole (especially under low pressure drop conditions), the present woven mesh tube provides a larger open flow area at the inside surface but relies in large part on the difficulty for the debris to pass entirely through the circuitous pathways all the way from the inside surface to the outside surface.

With both the drilled tube and woven mesh tube, all debris in the main axial flow stream has difficulty making a 90 degree turn into the tube openings. Whereas the operating principle of the tube with the drilled tube relies on the large debris not even entering the holes, the woven mesh tube can better accommodate debris because such debris is trapped between the inside and outside surfaces.

The woven tube wall shown in FIGS. 4 and 5 can be considered as a multi-layer composite sheet that is woven in the tubular form, sintered, and then cut to length. However, this preferred construction should not preclude other embodiments having variable weave, more layers, or double sheets.

The layering of the woven strands creates circuitous flow paths, with the mesh gradually reducing the allowance for particle size as the fuel approaches the clean side of the filter element. The layers are sintered which results in a strong bond between the layers that prevents flexing or dilation of the woven mesh. The mesh creates a flow matrix which has a much higher equivalent flow area compared to a drilled-hole tube. The mesh does not create a uniform shape or hole-count which can be easily defined. However, an effective surface porosity of 40% is a good indicator of open flow area.

The general method for fabricating a wound mesh tube for use in the present context is described more fully in U.S. Pat. No. 7,763,092, the disclosure of which is hereby incorporated by reference.

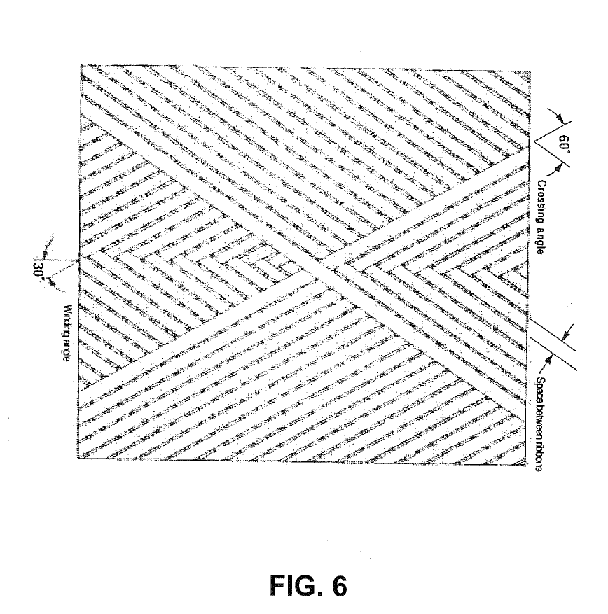

FIG. 6 shows another embodiment, in which the mesh is formed by wrapping ribbons or bands in the form of filaments, with each layer wrapped obliquely to the axis at an intersecting angle relative to an adjacent layer, thereby forming a multiplicity of circuitous flow paths passing entirely through the tube wall.

Regardless of embodiment, the mesh type debris shield comprises a tube fixed to the body, with a central passage aligned with the fuel supply passage and a tube wall consisting of a plurality of layers of metal mesh that together define a multiplicity of circuitous flow paths passing entirely through the tube wall. As used in the present disclosure, “mesh” should be understood as a pattern of intersecting filaments that define intervening openings, whether or not reinforced, and “intersecting” should be understood as including overlapping.

At least one layer, preferably at least two layers, are rigidly attached to an adjacent reinforcing layer or other mesh layer, preferably by sintering.

FIG. 7 also shows another mounting embodiment, for accommodating debris diverters that are longer than what is shown in FIG. 2 or 3. In the embodiment of FIG. 7, the chamber extends through the central portion 74 into the upper portion 70, where the main high pressure fuel passage 30a is counter bored 92. The counter bore 92 has an ID that is greater than the OD of the tube or shield 86, and thereby defines a shoulder or stop surface 94 to compress the upper end 96 of the tube, and also defines the outer wall of an annular space 98 whereby filtered fuel can flow to the gallery 100 in the central portion, for delivery through the branch line to the control valve.

FIG. 7 shows that the bottom end 102 of the shield is compressed at the end face against the lower body portion 72 whereas the top end of the shield is compressed by a conical stop surface 94 acting obliquely adjacent the end face, providing an obliquely oriented line of compression 104. The mesh tubes 86 are rigid yet sufficiently ductile that the neutral length is reduced by the longitudinal force component of the conical surface 94 without undermining the integrity of the tube. The line or annulus of compression 104 at the stop surface 94 can produce some radial compression of the tube end but this will either completely seal the line or where sealing is imperfect the gaps will be very much smaller than acceptable size of the debris.

1. A fuel injector comprising:
an elongated body having upper and lower ends, a longitudinal bore leading to an injector valve seat adjacent the lower end and to a tip with discharge holes at the lower end;
an injector valve reciprocable in said bore, having a lower end sealable against the injector valve seat and an upper end subject to fluid pressure in an injector control chamber;
a control valve with an upstream side in fluid communication with said injector control chamber and a downstream side in fluid communicating with a low pressure sump;
a high pressure fuel supply passage in the body, in fluid communication with said bore upstream of the injector valve seat, and a branch line from the high pressure passage in fluid communication with said injector control chamber and with the upstream side of said control valve;
an actuator for selectively closing and opening the control valve, whereby when the control valve is closed high pressure fuel in said control chamber urges the injector valve against the injector valve seat to prevent flow of high pressure fuel from said bore to the discharge holes and when the control valve is opened the control chamber is fluidly connected with the low pressure sump, thereby reducing the fluid pressure in the control chamber and on the upper end of the injector valve, lifting the injector valve off the injector seat and discharging fuel through the discharge holes;
a debris shield in the high pressure fuel supply passage upstream of said branch line, comprising a tube with a central passage aligned coaxially with the fuel supply passage and a perforated tube wall through which high pressure fuel is filtered transversely outward from the central passage for removal of debris before delivery to the branch line;
wherein the tube has opposite ends and a neutral length, and in an assembled condition of the injector the tube is axially compressed at both ends between spaced apart stop surfaces along the fuel supply passage, thereby producing a compressed length that is less than the neutral length and sealing the ends of the tube against passage of debris transversely across the ends of the tube.

2. The injector of claim 1, wherein the debris shield is situated in a shield chamber in the body, which shield chamber is defined by a shield chamber wall spaced radially from the tube and is fluidly connected to the branch line.

3. The injector of claim 1, wherein
the body comprises an upper portion containing the control valve and an upper portion of the fuel supply passage, a lower portion containing the injector valve and a lower portion of the fuel supply passage, and distinct central portion having upper and lower surfaces rigidly trapped between the upper and lower portions of the body and a shield chamber fluidly connecting the upper and lower portions of the fuel supply passage; and
the chamber is entirely within the central portion of the body, and the compressed length of the tube extends from the upper to the lower surface of the central portion of the body, whereby the tube is fixed to the body in longitudinal compression between the upper and lower portions of the body, by compressive engagement with the lower surface of the upper portion and compressive engagement with the upper surface of the lower portion, thereby sealing the opposed ends against the upper and lower portions.

4. The injector of claim 1, wherein
the body comprises an upper portion containing the control valve and an upper portion of the fuel supply passage, a lower portion containing the injector valve and a lower portion of the fuel supply passage, and distinct central portion having upper and lower surfaces rigidly trapped between the upper and lower portions of the body and a shield chamber fluidly connecting the upper and lower portions of the fuel supply passage; and
the chamber extends through the central portion into the high pressure fuel passage in the upper portion, where one of said stop surfaces is provided to compress the upper end of the tube.

5. The injector of claim 4, where the high pressure fuel passage is counter bored, with an ID that is greater than the OD of the tube, thereby defining a shoulder that forms said one stop surface.

6. The injector of claim 5, wherein the shoulder is conical.

7. The injector of claim 1, wherein the compressive force applied on at least one end of the tube is directed obliquely adjacent the end face of the tube.

8. The injector of claim 1, wherein the length of the compressed tube is shorter than the neutral length by 0.175-0.025 mm.

9. The injector of claim 1, wherein the debris shield prevent debris having an effective size greater than 30 microns from passing through the tube to the shield chamber.

10. A fuel injector comprising:
an elongated body having upper and lower ends, a longitudinal bore leading to an injector valve seat adjacent the lower end and to a tip with discharge holes at the lower end;
an injector valve reciprocable in said bore, having a lower end sealable against the injector valve seat and an upper end subject to fluid pressure in an injector control chamber;
a control valve with an upstream side in fluid communication with said injector control chamber and a downstream side in fluid communicating with a low pressure sump;
a high pressure fuel supply passage in the body, in fluid communication with said bore upstream of the injector valve seat, and a branch line from the high pressure passage in fluid communication with said injector control chamber and with the upstream side of said control valve;
an actuator for selectively closing and opening the control valve, whereby when the control valve is closed high pressure fuel in said control chamber urges the injector valve against the injector valve seat to prevent flow of high pressure fuel from said bore to the discharge holes and when the control valve is opened the control chamber is fluidly connected with the low pressure sump, thereby reducing the fluid pressure in the control chamber and on the upper end of the injector valve, lifting the injector valve off the injector seat and discharging fuel through the discharge holes;
a debris shield in the high pressure fuel supply passage upstream of said branch line, comprising a tube fixed to the body, with a central passage aligned with the fuel supply passage and a tube wall comprising a plurality of layers of metal mesh that together define a multiplicity of circuitous flow paths passing entirely through the tube wall.

11. The injector of claim 10, wherein at least one layer of the metal mesh consists of intersecting filaments that define distinct openings; and each layer is rigidly attached to an adjacent layer.

12. The injector of claim 10, wherein at least two layers of the metal mesh each consist of intersecting filaments that define distinct openings; and each layer is rigidly sintered to an adjacent layer.

13. The injector of claim 10, wherein the tube wall comprises a plurality of layers of metal ribbon filaments, each layer wrapped obliquely to the axis at an intersecting angle relative to an adjacent layer, thereby forming said multiplicity of circuitous flow paths passing entirely through the tube wall.

14. The injector of claim 10, wherein the tube wall has inner and outer surfaces, and comprises at least two layers of mesh, each layer defining openings between filaments, with an inner layer forming the inner surface and defining relatively larger openings and an outer layer forming the outer surface and defining relatively larger openings, thereby forming inlets and outlets of said multiplicity of circuitous flow paths passing entirely through the tube wall.

15. The injector of claim 10, wherein
the body comprises an upper portion containing the control valve and an upper portion of the fuel supply passage, a lower portion containing the injector valve and a lower portion of the fuel supply passage, and a distinct central portion having upper and lower surfaces rigidly trapped between the upper and lower portions of the body and a shield chamber fluidly connecting the upper and lower portions of the fuel supply passage;
the debris shield is situated in the shield chamber; and
the tube is situated at least in part within the central portion, and has opposed ends in longitudinal compression between upper and lower stop surfaces in the body.

16. The injector of claim 10, wherein
the body comprises an upper portion containing the control valve and an upper portion of the fuel supply passage, a lower portion containing the injector valve and a lower portion of the fuel supply passage, and a distinct central portion having upper and lower surfaces rigidly trapped between the upper and lower portions of the body and a shield chamber fluidly connecting the upper and lower portions of the fuel supply passage;
the debris shield is situated in the shield chamber; and
the tube has opposed ends extending from the upper to the lower surface of the central portion of the body, and the tube is fixed to the body in longitudinal compression between the upper and lower portions of the body, by compressive engagement with the lower surface of the upper portion and compressive engagement with the upper surface of the lower portion.

17. A fuel injector comprising:
an elongated body having upper and lower ends, a longitudinal bore leading to an injector valve seat adjacent the lower end and to a tip with discharge holes at the lower end;
an injector valve reciprocable in said bore, having a lower end sealable against the injector valve seat and an upper end subject to fluid pressure in an injector control chamber;
a control valve with an upstream side in fluid communication with said injector control chamber and a downstream side in fluid communicating with a low pressure sump;
a high pressure fuel supply passage in the body, in fluid communication with said bore upstream of the injector valve seat and a branch line from the high pressure passage in fluid communication with said injector control chamber and with the upstream side of said control valve;
an actuator for selectively closing and opening the control valve, whereby when the control valve is closed high pressure fuel in said control chamber urges the injector valve against the injector valve seat to prevent flow of high pressure fuel from said bore to the discharge holes and when the control valve is opened the control chamber is fluidly connected with the low pressure sump, thereby reducing the fluid pressure in the control chamber and on the upper end of the injector valve, lifting the injector valve off the injector seat and discharging fuel through the discharge holes;
a debris shield in the high pressure fuel supply passage upstream of said control valve said branch line, comprising a tube fixed to the body, with a central passage aligned with the fuel supply passage and a tube wall consisting of a plurality of layers of metal mesh that define a multiplicity of circuitous flow paths passing entirely through the tube wall;
wherein
the debris shield is situated in a shield chamber in the body, and the shield chamber is defined by a shield chamber wall spaced radially from the tube;
the body comprises a distinct upper portion containing the control valve and an upper portion of the fuel supply passage, a distinct lower portion containing the injector valve and a lower portion of the fuel supply passage, and a distinct central portion having a height defined between upper and lower surfaces that are rigidly trapped in contact between the upper and lower portions of the body and defining said shield chamber, which chamber fluidly connects the upper and lower portions of the fuel supply passage; and
the tube has a neutral length between opposed ends, that is greater than the height of the central portion and a shorter compressed length extending from the upper to the lower surface of the central portion of the body, whereby the tube is fixed to the body in longitudinal compression between the upper and lower portions of the body, by compressive engagement with the lower surface of the upper portion and compressive engagement with the upper surface of the lower portion, thereby sealing the opposed ends against the upper and lower portions.
